(19) United States
(12) Patent Application Publication
(10) Pub. No.: US 2021/0017682 A1
(43) Pub. Date: Jan. 21, 2021

(54) HYDROENTANGLED COMPOSITE FABRIC

(71) Applicant: Welspun India Limited, Mumbai (IN)

(72) Inventors: Dipali GOENKA, Mumbai (IN); Pranay SAHU, Mumbai (IN); Subrata PALIT, Mumbai (IN); Umasankar MAHAPATRA, Mumbai (IN)

(73) Assignee: Welspun India Limited, Mumbai (IN)

(21) Appl. No.: 16/934,594

(22) Filed: Jul. 21, 2020

(30) Foreign Application Priority Data
Jul. 21, 2019 (IN) 201921029368

(51) Int. Cl. D04H 3/11; D03D 11/00

(52) U.S. Cl. CPC D04H 3/11; D03D 11/00; D10B 2403/023; D10B 2401/13; D10B 2401/06

(57) ABSTRACT

The present disclosure describes a hydroentangled composite fabric. The composite fabric includes a base woven fabric having a plurality of warp yarns and a plurality of weft yarns interwoven with the plurality of warp yarns. The composite fabric also includes a web of nonwoven fibers hydroentangled with and within the plurality of warp yarns and the plurality of weft yarns, such that the nonwoven fibers are substantially entangled with fibers of the plurality of warp yarns and fibers of the plurality of weft yarns.

### CROSS-REFERENCE TO RELATED APPLICATIONS

The present application claims priority to and the benefit of Indian Patent Application Number 201921029368, filed Jul. 21, 2019, the entire contents of which are incorporated by reference herein.

### TECHNICAL FIELD

The present disclosure relates to a hydroentangled composite fabric and a method of making such a hydroentangled composite fabric.

### BACKGROUND

Woven fabrics made from cotton yarns or cotton blended yarns are widely used for bedding and other home textile applications due to several properties these particular fabrics possess. Woven fabrics are comfortable, compatible with coloring techniques and design applications, durable and stable when laundered repeatedly, strong, resilient and colorfast. Certain woven fabrics may be made wrinkle-free as well, as is common in sheets and bedding fabrics. Woven fabrics are also receptive to modifications that impart additional desirable properties, such as stain release, anti-microbial properties and moisture wicking, leading to added comfort. Balancing fiber selection, yarn design, fabric design, and process parameters with desired end use properties is difficult in application where comfort is an important decision point for consumers, such as bedding applications. Typical structures used in bedding applications, such as cotton and cotton blended yarns, or cotton/polyester blended fabrics present challenges in achieving the right balance of strength, durability, softness, moisture management, and other properties that are associated with these materials.

Nonwoven fabrics made using techniques such as hydroentanglement have certain advantages over traditional woven fabrics. For example, nonwoven fabrics made by hydroentanglement, where loose fibers are entangled with each other, are more soft and absorbent than woven textile materials, which are composed of yarns made through the tight interlacing of fibers or threads. In certain applications, nonwoven fabrics may be combined with woven fabrics to produce composite fabrics that achieve the benefits of both.

### SUMMARY

There is a need for composite fabrics that leverage the benefits of both woven and nonwoven fabrics such as high durability, wrinkle-free properties, lightness, moisture management, softness and anti-allergen properties. An embodiment of the present disclosure includes a hydroentangled composite fabric, comprising: a base woven fabric having a plurality of warp yarns, a plurality of weft yarns interwoven with the plurality of warp yarns, and interstitial spaces between the plurality of warp yarns and the plurality of weft yarns. The hydroentangled composite fabric also includes a web of nonwoven fibers hydroentangled a) within the interstitial spaces, and b) with the plurality of warp yarns and the plurality of weft yarns, such that the nonwoven fibers are substantially entangled with each other and with fibers of the plurality of warp yarns and fibers of the plurality of weft yarns. The hydroentangled composite fabric also includes a plurality of pores defined by the web of nonwoven fibers, the plurality of warp yarns, and the plurality of weft yarns, wherein the plurality of pores have a diameter up to about 10 microns, thereby defining the hydroentangled composite fabric.

In accordance with the illustrated embodiment, the hydroentangled composite fabric may have an air permeability of less than six centimeters cubed per centimeters squared per second according to test method ASTM D 737-96. The hydroentangled composite fabric may have a shrinkage that is less than one percent according to test method AATCC 150. The hydroentangled composite fabric may have a durable press rating of at least 3.0 according to test method AATCC 143. The hydroentangled composite fabric may have no detectable formaldehyde content according to BS EN ISO 14184 test methods. The hydroentangled composite fabric may have a wicking distance of at least 13 centimeters during a time period of thirty minutes according to test method AATCC 197. The hydroentangled composite fabric has a tensile strength of at least 80 pounds according to test method ASTM D 5034.

In accordance with another embodiment of the present disclosure, the hydroentangled composite fabric has a basis weight between 80 grams per square meter and 550 grams per square meter. The hydroentangled composite fabric has a thread count between 100 and 1000. The hydroentangled composite fabric, wherein the base woven fabric has a) a warp end density between about 50 warp ends per inch and about 350 warp ends per inch, and b) a weft end density between about 50 weft yarns per inch and about 700 weft yarns per inch.

In accordance with another embodiment of the present disclosure, the hydroentangled composite fabric includes a plurality of warp yarns that are selected from the group consisting of natural spun yarns, synthetic spun yarns, synthetic filament yarns, and blended yarns. The hydroentangled composite fabric includes a plurality of weft yarns selected from the group consisting of natural spun yarns, synthetic spun yarns, synthetic filament yarns, and blended yarns. The hydroentangled composite fabric comprises a base woven fabric, wherein the base woven fabric comprises pores having a diameter of at least about 40 microns.

An embodiment of the present disclosure includes a method for forming a hydroentangled composite fabric, the method comprising: weaving a plurality of warp yarns with a plurality of weft yarns to define a base woven fabric comprising pores with a diameter of at least about 40 microns. The method also includes combining the base woven fabric with at least one web of nonwoven fibers. The method also includes applying high pressure water jets to the base woven fabric and the at least one web of nonwoven fibers to generate a hydroentangled composite fabric having pores with a diameter up to about 10 microns. The method also includes drying the hydroentangled composite fabric to substantially remove moisture from the hydroentangled composite fabric.

In accordance with the illustrated embodiments, either or both of the warp yarns and the weft yarns comprise synthetic fibers and the method comprises heat setting the hydroentangled composite fabric. The method further includes pre-treating the base woven fabric with high pressure water jets before the step of applying high pressure water jets. Applying high pressure water jets comprises applying high pressure water jets with an oscillating nozzle. In addition, applying high pressure water jets comprises applying high pressure water jets at an angle. In this method, the high pressure water jets are applied at a pressure of 50 bars to 400 bars.

### BRIEF DESCRIPTION OF THE DRAWINGS

The foregoing summary, as well as the following detailed description of illustrative embodiments of the present application, will be better understood when read in conjunction with the appended drawings. For purposes of illustrating the present application, the drawings show exemplary embodiments of the present disclosure. It should be understood, however, that the present disclosure is not limited to the precise arrangements and instrumentalities shown in the drawings. In the drawings:

FIG. 1 is a schematic of a hydroentangled composite fabric according to an embodiment of the present disclosure;

FIG. 2 is a cross-sectional view of a hydroentangled composite fabric taken along line 2-2 in FIG. 1;

FIG. 3 is a process flow diagram for a method of making a hydroentangled composite fabric according to an embodiment of the present disclosure;

FIG. 4 is a schematic of a manufacturing system used to form a hydroentangled composite fabric according to an embodiment of the present disclosure;

FIG. 5 is a schematic of a manufacturing system used to form a hydroentangled composite fabric according to another embodiment of the present disclosure;

FIG. 6A is an image showing a base woven fabric before hydroentangling a web of nonwoven fibers with the base woven fabric according to an embodiment of the present disclosure;

FIG. 6B is an image showing a hydroentangled composite fabric after the base woven fabric shown in FIG. 5A is subjected to hydroentangling with a web of nonwoven fibers;

FIG. 7 is a chart summarizing data obtained for embodiments of the present disclosure;

FIG. 8 shows a comparison of the pore sizes of a hydroentangled composite fabric according to an embodiment of the present disclosure to that of other fabrics;

FIG. 9 shows a comparison of the air permeability of a hydroentangled composite fabric according to an embodiment of the present disclosure to that of other fabrics;

FIG. 10 shows a comparison of the dimensional stability of a hydroentangled composite fabric according to an embodiment of the present disclosure to that of other fabrics;

FIG. 11 shows a comparison of the durable press rating of a hydroentangled composite fabric according to an embodiment of the present disclosure to that of other fabrics;

and

FIG. 12 shows a comparison of the warp tensile strength of a hydroentangled composite fabric according to an embodiment of the present disclosure to that of other fabrics.

### DETAILED DESCRIPTION OF ILLUSTRATIVE EMBODIMENTS

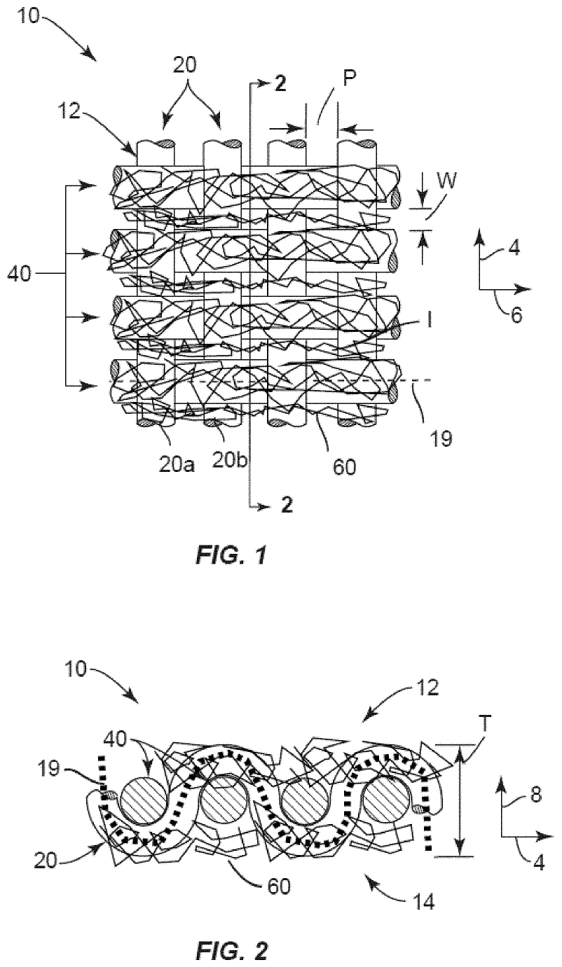

Referring to FIG. 1, an embodiment of the present disclosure includes a hydroentangled composite fabric 10. The hydroentangled composite fabric 10 includes a base woven fabric 12 with a warp component having warp yarns 20 and a weft component including weft yarns 40 that are interwoven with the warp yarns 20. The warp yarns 20 extend along a warp direction 4 and the weft yarns 40 extend along a weft or fill direction 6 that is perpendicular to the warp direction 4. The warp yarns 20 and weft yarns 40 are interlaced are define interstitial spaces I between them. The fabric 10 has a thickness dimension T that is perpendicular to the warp direction 4 and weft direction 6.

The hydroentangled composite fabric 10 further includes a web of nonwoven fibers 60 that are hydroentangled a) within interstitial spaces I, defined by a distance between adjacent warp yarns P measured in the weft direction 6 and a distance between adjacent weft yarns W in the warp direction 4, and b) with the plurality of warp yarns 20 and the plurality of weft yarns 40. The process to make the composite fabric 10 is such that the nonwoven fibers 60 are substantially entangled with each other and with fibers of the plurality of warp yarns 20 and fibers of the plurality of weft yarns 40. In certain embodiments, the combination of the base woven fabric 12 and web of nonwoven fibers define pores having a diameter up to about ten microns, thereby defining an anti-allergen hydroentangled composite fabric. The inventors have surprisingly found that particular fabric, nonwoven fiber constructions, and the process used creates fabrics with high durability, wrinkle-free properties, improved moisture management, softness, strength, and anti-allergen properties. In particular, the web nonwoven fibers 60 are hydroentangled with the base woven fabric 12 through the application of high pressure water jets. A hydroentangled composite fabric 10 as described herein may be suitable for anti-allergen bedding applications, such as sheets, fitted sheets, pillow cases, shams, duvets, blankets, comforters, pillow cases, mattress covers, and/or mattress pads.

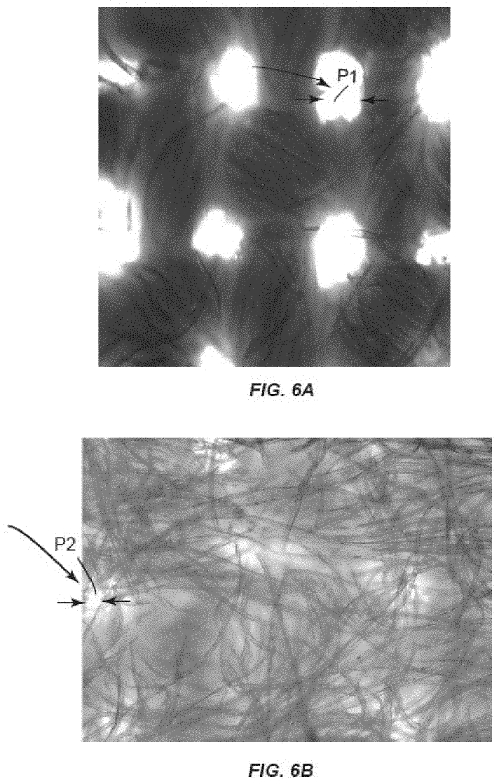

Referring to FIG. 1 along with FIGS. 6A and 6B, the hydroentangled composite fabric 10 has a plurality of compact pores P2 that are formed by the blockage of the larger pores P1 of the base woven fabric 12. The base woven fabric defines pores P2 that are reduced in size after hydroentanglement. As shown in FIG. 1, the pores P2 of the hydroentangled composite fabric have diameters of up to about t10 microns, defining an allergen barrier of the hydroentangled composite fabric. Pore size as used herein is measured according to ASTM D 6767, using the edition available as of the filing of the present application. As explained below, the reduced pore dimensions are a result of nonwoven fibers becoming entangled with the base woven fabric during the hydroentanglement process and occupying the larger pores P1 between the plurality of warp yarns 20 and plurality of weft yarns 40 of the base woven fabric. For example, in one instance, a base woven fabric of 200 thread count percale construction with warp and weft yarns of 75 denier, interlaced at 105 ends per inch (EPI) and 95 picks per inch (PPI) has pores of 40-50 microns prior to hydroentanglement. After hydroentanglement, the pores have diameters of only up to about 8-10 microns. Although 8-10 micron pores have been found to be advantageous, in certain embodiments, however, the pores P2 may be up to about fifteen (15) microns or even slightly higher. As used herein, the abbreviation TC means “thread count”, D means “denier”, EPI means “ends per inch” and PPI means “picks per inch”, as will be understood by one of ordinary skill in the art.

A number of different woven structures may define the base woven fabric 12 of a hydroentangled composite fabric 10 described herein or woven design repeats. As used herein, a woven design repeat includes at least a first warp yarn 20a, a second warp yarn 20b, and at least one weft yarn 40. For example, a plain weave fabric has a woven design repeat that includes two adjacent warp yarns 20 and two adjacent weft yarns 40. Depending on the particular design, woven design repeats may repeat along: a) the warp direction 4; b) the weft direction 6; or both the warp direction 4 and weft direction 6. However, the design of the woven fabric is not limited to a plain weave. For example, the woven fabric can have a number of exemplary woven structures, including but not limited to: plain weaves; basket weaves, rib weaves (e.g. 2×1 rib weave; 2×2 rib weave; or 3×1 rib weave) twill weaves; oxford weaves; percale weaves, satin weaves (e.g., satin dobby base, satin stripe satin 5/1, satin 4/1 satin; 4/1 satin base strip; 4/1 stain swiss dot; 4/1 down jacquard;5/1 satins), sateen weaves, or percale weaves. In one example, the woven fabric is a plain weave. In another example, the woven fabric is a basket weave. In another example, the woven fabric is a percale weave. In another example, the woven fabric is a rib weave. In another example, the woven fabric is a twill. In another example, the woven fabric is an oxford weave. In another example, the woven fabric is a satin weave. Furthermore, a number of exemplary satin constructions are possible. For instance, in one satin weave example, the woven fabric is a 4/1 satin. In another example, the woven fabric is a 4/1 satin dobby diamond weave. In another example, the woven fabric is a 4/1 satin dobby stripe. In yet another example, the woven fabric is a 4/1 satin jacquard weave. In another example, the woven fabric is a 5/1 satin. In still another example, the woven fabric may be a 6/1 satin. In another example, the woven fabric is a 7/1 satin. In yet another example, the woven fabric is an 8/1 satin. In another example, the woven fabric is a 9/1 satin. In another example, the woven fabric is a 10/1 satin.

So-called “co-insertion” techniques may be used to insert multiple weft yarns 40 along a weft insertion path 19 in a single weft insertion event during weaving, as will be further detailed below. The weft insertion path 19 is in dashed lines in FIG. 1. As used herein, the weft insertion path 19 extends along the weft direction 6 around the warp yarns 20 across an entirety of the width of the woven fabric. As illustrated, the weft insertion path extends under (with respect to the sheet) warp 20a, over warp yarn 20b, and so on. A person of skill in the art will appreciate that the weft insertion path 19 varies from one woven design to another woven design.

“Co-insertion” is where multiple picks or weft yarns are inserted into the warp shed at one time during weaving. In co-insertion, two pick yarns supplied from two different yarn packages are inserted at one time through the shed during weaving. Co-insertion may also include inserting three or more yarns supplied from the three or more different yarn packages into the shed during weaving. In one example, the woven fabric has between one weft yarn and 12 weft yarns inserted during a single insertion event, i.e., along the weft insertion path 19. By inserting groups of multiple weft yarns into the shed during a weft insertion event, it is possible to attain increased weft (or pick or fill) densities and therefore higher thread counts. Thus, a woven fabric as described herein may be constructed to have higher weft yarn densities than what is otherwise possible, and thus higher thread counts, yet the woven fabric exhibits desirable fabric quality, softness, hand, and drape suitable for bedding applications. The thread count of the woven fabrics made in accordance with present disclosure is typically greater than about 80 and can be as high as about 1000 (or even higher). The thread count as used herein is the total number of yarns in square inch of fabric. The thread count in this context is based on total number of yarn ends. In other words, a plied yarn is considered one yarn for determining thread count.

The warp yarns and weft yarns are arranged to achieve desired warp and weft end densities, respectively, and thus desired thread count, for bedding applications. In accordance with an embodiment of the present disclosure, the woven fabric has a warp end density between about 50 warp ends per inch and about 350 warp ends per inch. In one example, the warp end density is between about 50 and 150 warp ends per inch. In another example, the warp end density is between about 150 and 250 warp ends per inch. In another example, the warp end density is between about 250 and 350 warp ends per inch. Furthermore, the weft yarns are arranged to define a weft end density between about 50 weft yarns per inch and about 700 weft yarns per inch (or more). In one example, the weft yarn density is between about 100 and about 700 weft yarns per inch. In one example, the weft yarn density is between about 100 and about 300 weft yarns per inch. In another example, the weft yarn density is between about 300 and about 500 weft yarns per inch. In another example, the weft yarn density is between about 500 and about 700 weft yarns per inch. The weft yarn density as used herein refers to the total number of separate weft yarns along a length of the woven fabric. For example, a weft yarn density of about 50 picks per inch refers the 50 total weft yarns per inch of woven fabric. If the weft yarn groups are inserted during a single weft insertion event and each group includes three weft yarns, then there would be about 16 total weft yarn groups per inch of fabric and 48 picks per inch.

The yarns (warp or weft) can have a range of counts for the different fibers and woven constructions as described herein. The yarn count can range between about 8 Ne (664 denier) to about 120 Ne (44.3 denier). In one example, the yarns can have a count in a range between about 8 Ne (664 denier). In one example, the yarns can have a count in a range between about 20 Ne (266 denier). In one example, the yarns can have a count in a range between about 30 Ne (177 denier). In one example, the yarns can have count in a range between about 40 Ne (133 denier). In another example, the yarns have a count of about 60 Ne (88.6 denier). In another example, the yarns have a count of about 70 Ne (75.9 denier). In another example, the yarns have a count of about 80 Ne (66.4 denier). In another example, the yarns have a count of about 100 Ne (53.1 denier). In another example, the yarns have a count of about 120 Ne (44.3 denier). For hydroentangled woven fabrics, the warp yarn counts may range from 20 Ne (266 denier) to about 100 Ne (53.1 denier). The weft yarn counts may range from 20 Ne (266 denier) to about 120 Ne (44.3.1 denier).

A hydroentangled composite fabric 10 can have a variety yarn constructions for the warp and weft components of the base woven fabric. For instance, the yarns (warp or weft) may be spun staple yarns or filament yarns. In accordance with one embodiment, the woven fabrics include staple yarns formed from natural fibers or a blend of natural and synthetic fibers. In one example, the staple yarns are spun, cotton fiber yarns or blended yarns. While the staple yarn is preferably cotton, in certain alternative embodiments, the staple yarn can include cotton fibers blended with other natural or synthetic fibers. In such an example, the natural fibers could include silk, linen, flax, bamboo, hemp, wool, and the like. The synthetic fibers in this example are those fibers that result in fabric structures with good hand, drape, and softness. Such synthetic fibers include cellulosic fibers, including rayon fibers (e.g., Modal, lyocell) or thermoplastic fibers, such as polyethylene terephthalate (PET) fiber, polylactic acid (PLA) fiber, polypropylene (PP) fibers, polyamide fibers, and microfiber staple fibers.

The staple yarns can be formed using a variety of staple yarn formation systems. For instance, staple yarn formation may include bale opening, carding, combing, drafting, roving, and yarn spinning (yarn spinning processes are not illustrated) to the desired count and twist level. In some cases, the staple yarns can be plied into 2-ply, 3-ply, or 4-ply configurations. After yarn spinning, the staple yarns are wound into the desired yarn packages for weaving. In one example, ring spinning is the preferred spinning system. However, the staple yarns can be formed using open end spinning systems, rotor spun spinning systems, vortex spinning systems, core spinning yarns, jet spinning yarns, or compact spinning systems. Furthermore, the spinning system may include methods used to form Hygrocotton®, disclosed in U.S. Pat. No. 8,833,075, entitled “Hygro Materials for Use In Making Yarns And Fabrics,” (the 075 patent). The 075 patent is incorporated by reference into the present disclosure. Accordingly, the staple yarns can be ring spun yarns, open end yarns, rotor spun yarns, vortex spun yarns, core spun yarns, jet spun yarns, or compact spun yarns. In another embodiment, the warp yarns can be Hygrocotton® yarns marketed by Welspun India Limited. Furthermore, yarns can be formed as disclosed in the 075 patent. Preferably, the staple yarn is a ring spun yarn. The staple yarn, however, may be any type of spun yarn structure.

For spun yarns, twist level is an important parameter in final yarn structure. Twist is imparted during spinning to bind the fibers together into yarn structure. The twist level of the yarn is typically optimized to provide the desired strength to aid in weaving. If the twist level is too high, the forces applied to fibers are high, which may cause in fiber breakage, and yarn break in the weaving process. With increased twist levels, the fibers in the yarn are more compact and softness and absorbency of the yarn is reduced. This can result in less than ideal softness in final woven products. Often this is addressed, to some extent, by adding hand modifiers during the dyeing and finishing process. There are, however, drawbacks, such as costs, increased waste water, energy usage, and other environmental concerns. Due to this tradeoff, there is a certain limitation of woven fabrics in terms of softness and absorbency. The present disclosure addresses this tradeoff by permitting typical high twist yarns to be used during manufacturing, while achieving the result of having a low-twist yarn in the final fabric construction.

The woven fabric may also include continuous filament yarns. In one example, the continuous filament yarns are polyethylene terephthalate (PET) filament yarns. While the continuous filament yarns are primarily formed from PET, in alternative embodiments, the continuous filament, high bulk yarn are formed from other synthetic filaments, such as polylactic acid (PLA) fiber, polypropylene (PP) fibers, and polyamide fibers. Embodiments of the present disclosure include the continuous filament yarns dyed prior to fabric formation. For example, the continuous filament yarns can be a dope-dyed, continuous filament yarn. In another example, the continuous filament yarns can be dyed using disperse dyes via package dyeing process (not shown). As used herein, a “dyed continuous filament yarn” means a yarn dyed prior to fabric formation whereby coloring agents are within the morphology of the filaments that form the yarns.

A hydroentangled composite fabric 10 can use different yarn constructions in the warp and weft components of the base woven fabric. In one example, the warp yarns are staple spun yarns (cotton or any fiber blends) and the weft yarns may include staple yarns. In one example, the warp yarns are continuous filament yarns and the weft yarns are staple spun yarns. In one example, the weft yarns are continuous filament yarns and the warp yarns are staple spun yarns. In another example, the warp yarns include staple yarns and filament yarns and the weft yarns include staple yarns and filament yarns.

While the yarns are described in relation to the process used to make them, one of skill in the art will appreciate that each staple yarn described above has structural differences unique to each yarn formation system. Thus, the description of the yarns above is also a description of yarn structure.

The base woven fabric of the hydroentangled composite fabric 10 has a range of basis weights. For instance, the base woven fabric has a basis weight in the range of about 100 grams per square meter to about 330 grams per square meter. In one embodiment, the basis weight of the base woven fabric is in the range of about 150 grams per square meter to about 250 grams per square meter. In another embodiment, the basis weight of the base wove fabric is in the range of about 170 grams per square meter to about 200 grams per square meter. The basis weight of the base woven fabric may fall outside the ranges stated in this paragraph as well. The basis weight referred to herein can be determined according to ISO 9073-1:1989, Textiles—Test methods for nonwovens—Part 1: Determination of mass per unit area.”

The web of nonwoven fibers 60 can be a dry laid fibrous assembly of staple fibers. Details concerning how the web of nonwoven fibers is formed are further discussed below. As used herein, the web of nonwoven fibers includes synthetic or manmade cellulosic fiber and/or natural cellulosic fibers. Manmade cellulosic fibers include but are not limited to: regenerated cellulose; viscose; rayon; lyocell; cellulose nitrate; carboxymethyl cellulose, and the like. Natural cellulosic fibers include but are not limited to: cotton; wood pulp; jute; hemp; sphagnum, and the like. In one embodiment, the web of nonwoven fibers are viscose fibers. For viscose fibers, the staple length can be about 5 mm to about 50 mm. The denier can be about 2 to about 6 and the staple fiber size of from about 15 microns to about 28 microns. In another embodiment, the fibers of the web of nonwoven fibers are cotton fibers. When cotton fibers are used, the cotton fibers have a staple length of about 5 millimeters (mm) to about 30 mm. The cotton fibers can generally have a fiber size of about 150 microns to about 280 microns. The cotton fibers can also be bleached if desired. In a further embodiment, the web of nonwoven fibers includes a blend of viscose and cotton fibers. Other blends are possible. In accordance with one embodiment of the present disclosure, the web of nonwoven fibers may have basis weight in the range of about 100 grams per square meter to about 300 grams per square meter.

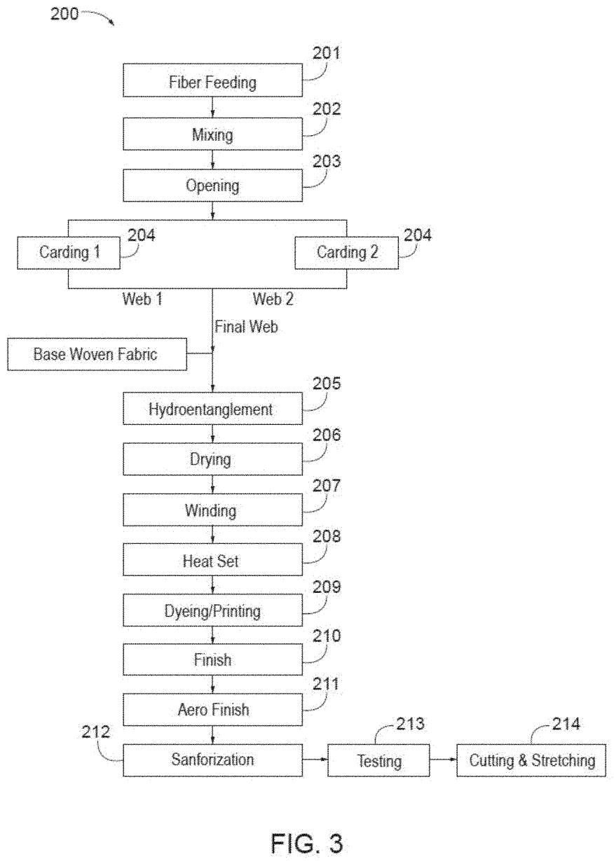

Turning now to FIGS. 3-5, a process flow 200 and manufacturing systems 300, 400 for manufacturing the hydroentangled composite fabric 10 are illustrated. The process 200 illustrated is designed to form a hydroentangled composite fabric 10 as described here. In general, the process includes fiber feeding 201, mixing 202, opening 203, and carding 204 to a first web 342a (Web 1) and a second web 342b (Web 2). The first and second webs 342a and 342b are combined into a single web 344 (Final Web). As further explained below, the single web 344 is combined with the base woven fabric 12 and advanced into the hydroentanglement unit 350 for hydroentanglement 205. Although carding is illustrated, other drylaid web formation systems may be used. After hydroentanglement 205, which will be described in more detail in FIG. 3, the hydroentangled composite fabric 10 undergoes drying 206, winding 207, heat set 208, optional mercerization (not shown), dyeing (or printing) 209 and finishing 210. After finishing 210, the hydroentangled composite fabric 10 is optionally subjected to aero finishing 211 then sanforization 212. The finished product is then subjected to testing 213, followed by cutting and stretching 214, or more generally “converting”. It should be appreciated that the process may be vertically integrated and include process operation from fiber feeding 201 through converting as illustrated.

Referring to FIG. 3, the manufacturing system 300 includes a fiber feeding zone 310, a multimixer 320, a fine opener 330, a first carding machine 340a and a second carding machine 340b. The two carding machines 340a, 340b may operate in parallel to form a first web of nonwoven fibers 342a and a second web of nonwoven fibers 342b. The first and second webs 342a, 342b are combined into a final web of nonwoven fibers 344 and transported to the hydroentanglement unit 350.

Continuing with to FIG. 3, the hydroentanglement unit 350 includes a plurality of drums 360, 362, 364 and each drum including a number of nozzle assemblies. As illustrated, the unit 305 includes 6 total water jet nozzle assemblies (shown as 371-376) through three different drums 360, 362, and 364. Under high water jet pressure, the fiber web 60 penetrates inside the base woven fabric structure 12, entangling with the fibers in the warp yarns and weft yarns, while also entangling with each other in the interstitial spaces I (FIGS. 1 and 2). The result is that the nonwoven fibers 60 block the larger pores P1 (as shown in FIG. 6A) of the base woven fabric 10 to define compact pores P2 (as shown in FIG. 6B) of an anti-allergen hydroentangled composite fabric 10. The fabric 10 then moves to a hot air drying zone 380 and then winding zone 390.

Referring still to FIGS. 3-5, the hydroentanglement step 205 applies high pressure water jets to base woven fabric 12 and Final Web 344 of nonwoven fibers. The hydroentanglement unit 350 includes one or more high pressure assemblies (shown to include high pressure water jets 371-376). Each high pressure assembly includes a water jet nozzle assembly. The number of high pressure assemblies can be from 2 to 10. Six high pressure assemblies are shown for illustrative purposes. More than six or less than four could be used. Each nozzle assembly is configured to eject a plurality of high pressure water jets into drums of the hydroentanglement unit 350. Each high pressure assembly includes a perforated forming cylinder that carries composite along each water jet nozzle assembly where high pressure jets are ejected into the composite, thereby forming the hydroentangled composite fabric of the present disclosure. In accordance with an embodiment of the present disclosure, the high pressure water jets are applied to the base woven fabric 12 and nonwoven 344 simultaneously at a pressure of 100 to 400 bars. After passing through the composite, the water enters a vacuum chamber through a perforrated sleeve of the cylinders. Following application of the water jets to the composite fabric, a second conveyer member advances the fabric toward the next process step.

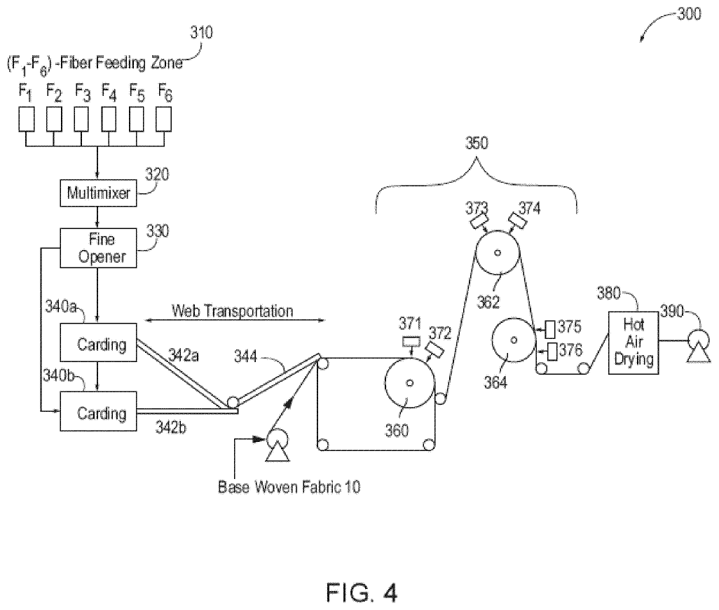

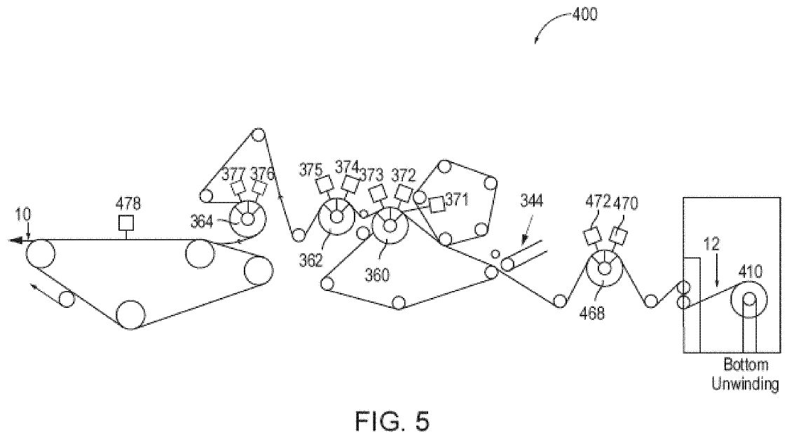

FIG. 5 illustrates an alternative system compared to that shown in FIG. 4 and described above. The system 400 shown in FIG. 5 includes the same basic components as that system 300 shown in FIG. 4. For that reason, features that are common between the system 300 shown in FIG. 3 and the system 400 shown in FIG. 5 will have the same reference numbers. However, the embodiment of the system shown in FIG. 5 includes an additional nozzle assembly 468 that is used to pre-treat the woven base fabric 12 and another nozzle assembly 478 to treat the composite fabric 10 following exit form the drum 364 and nozzle assemblies 376 and 377. As shown in FIG. 5, from bottom unwinding area 410 the base woven fabric 12 moves along drum 468. The nonwoven web 344 is introduced into the process as the base woven fabric 12 advances from drum 468 and drum 360. The base woven fabric 12 and web 344 together move toward 360 where the material is pre-wetted by water jet 371 under water pressure of up to about 35 bars. As shown, two water jet nozzles 372 and 373 are used to apply high pressure water jets to the materials riding along the drum 360. The water jets are applied up to about 75 bars of pressure. However, the pressure may be more or less than that at this stage. The material then moves to drum 362 where again two high pressure water jets are applied on the material via water jet assemblies 374 and 375. The pressure of water jets from nozzle 374 may be up to about 250 bars and in nozzle 375 up to about 360 bars. The material then moves to drum 364 where again two water jet 377 and 376 are applied on the material. The water pressure is 360 and 280 bars, respectively, in nozzles 377 and 376. The material is then passed through finishing and final water jet nozzle assembly 478 under water pressure of about 50 bars. Depending on the requirements the water pressure varies in case of all nozzles. The jet nozzles have 40 -80 holes per square inch with the diameters of the water jet nozzles being 100-120 microns. It should be appreciated that the configuration of water jet assemblies may vary as needed. Furthermore, the pressures may be changed as circumstances require.

The hydroentangement step 205 forms the structure of the hydroentangled composite fabric. As can be seen FIGS. 6A and 6B, the nonwoven fibers 60 migrate inside of the warp and weft yarns of the base woven fabric. It can be seen that the loose fibers penetrate inside the base woven fabric and get trapped and entangled with individual fibers of the base woven fabric. As a result, the “openness” of the base woven fabric is compacted through the hydroentanglement process. Comparing FIG. 6A to FIG. 6B, one of ordinary skill in the art will appreciate visually the structural changes to the base woven fabric that take place during the hydroentanglement process. In general, the application of water jets throughout the hydroentanglement process decreases the size of the pores of the woven fabric as seen in FIG. 6A. Furthermore, as explained below, the resulting fabric has reduced air permeability and may have an allergen barrier defined by the reduced pore sizes throughout the hydroentangled composite fabric.

During hydroentanglement, the high pressure water jets cause the pores of the base woven fabric P1 to become blocked by nonwoven fibers. The fabric becomes compacted and the pore sizes are significantly reduced. For example, a base woven fabric of 200TC percale with warp and weft yarns of 75 denier (105″×95″) has pores of 40-50 microns in diameter prior to hydroentanglement, as depicted in FIG. 6A, where after hydroentanglement the pores have diameters of only 8-10 microns, as depicted in FIG. 6B. In this experiment, lyocell standard Tencel® fibers were used. However, bleached or unbleached cotton or cotton blended with lyocell, Modal, polyester, or other textile fibers may be used.

Referring again to FIGS. 4 and 5, the hydroentangled composite fabric 10 is introduced to a drying unit via a conveyor to remove moisture from the hydroentangled composite fabric 10. Following the drying, the hydroentangled composite fabric may have a basis weight in the range of about 50 grams per square meter to about 550 grams per square meter. In one embodiment, the basis weight of the hydroentangled composite fabric is in the range of about 150 grams per square meter to about 250 grams per square meter. In another embodiment, the basis weight is in the range of about 170 grams per square meter to about 200 grams per square meter.

After drying, when thermoplastic fibers are used in the base woven fabric and/or the nonwoven web of fibers, the hydroentangled composite fabric is subjected to a heat set step to stabilize the fibers inside the fabric. Heat setting occurs at 190 to 200 degrees centigrade in a stenter machine with a contact time of 45 to 60 seconds to thermally set the fabric.

The process 200 includes an optional dyeing/printing step 209 and a finishing step after hydroentanglement 205. The dyeing/printing 209 applies color and the finishing step 210 applies one or more functional agents to the fabric. In an embodiment, the hydroentangled composite fabric is dyed with reactive dyes using a pad dry, pad steam, or cold pad batch method. The finishing step 210 may also include applying a composition including one or more of the functional agents to the hydroentangled composite fabric 10. The functional agents may include a softener, antimicrobial agent, etc. Next, excess moisture is removed by advancing the fabric through a heating machine. Heating machines may be heated steam, infrared, hot air, surface rolls, hot oil can, through-air ovens, and like machines. After drying, the woven fabric may be sanforized and calendared to adjust the hand and better control over shrinkage.

Continuing with FIG. 3, after the dyeing/printing 209 and finishing steps, including sanforization 212, the hydroentangled composite fabric 10 is converted to a bedding article as described herein.

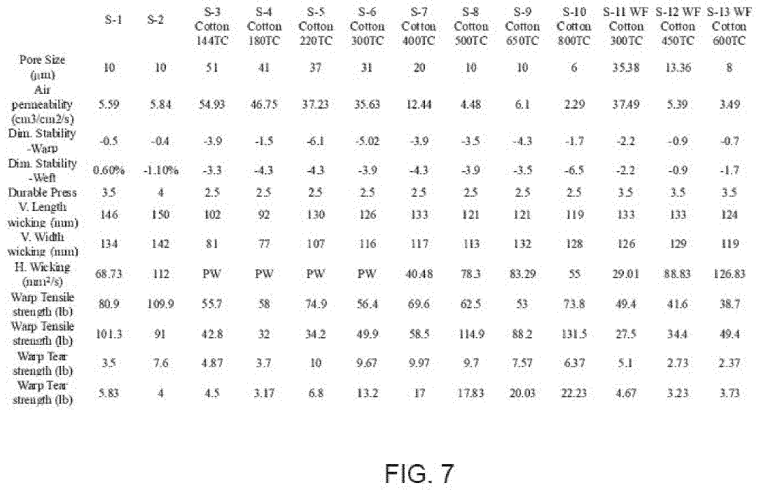

The hydroentangled composite fabric 10 has unique properties suitable for barrier and/or anti-allergen applications. It has been surprisingly found the fabrics made in accordance with the present disclosure may possess anti-allergen properties yet are functionally suitable for bedding applications. Typically, woven fabrics are used for sheeting application. Nonwoven materials, on the other hand, can possess good barrier properties but do not possess the comfort and durability that bedding applications require. The hydroentangled composite fabric 10 of the present disclosure is a synergistic result of woven fabric construction and nonwoven processing. In evaluating the fabrics of the present disclosure, various example fabrics were constructed as summarized in FIG. 7. Samples S-1 and S-2 were made in accordance with the present disclosure and using viscose fibers for the nonwoven web of fibers. Samples S-2 through S-10 are woven sheeting fabrics with increasing thread counts, made of cotton yarns. Samples S-11, S-12 and S-13 are woven sheeting fabrics with increased thread counts using hydroentanglement to treat the fabrics.

TABLE 1
Sample Constructions

| Example | Construction |
|---|---|
| S-1 | Hydroentangled composite fabric 10 -Dyed |
| S-3 | Hydroentangled composite fabric 10 - Printed |
| S-3 | Woven percale, 140 thread count, 100% cotton |
| S-4 | Woven percale, 180 thread count, 100% cotton |
| S-5 | Woven percale, 220 thread count, 100% cotton |
| S-6 | Woven percale, 300 thread count, 100% cotton |
| S-7 | Woven percale, 400 thread count, 100% cotton |
| S-8 | Woven percale, 500 thread count, 100% cotton |
| S-9 | Woven percale, 650 thread count, 100% cotton |
| S-10 | Woven percale, 800 thread count, 100% cotton |
| S-11 | Hydroentangled with fibers, 300 thread count, |
| | 100% cotton |
| S-12 | Hydroentangled with fibers, 450 thread count, |
| | 100% cotton |
| S-13 | Hydroentangled with fibers, 600 thread count, |
| | 100% cotton |

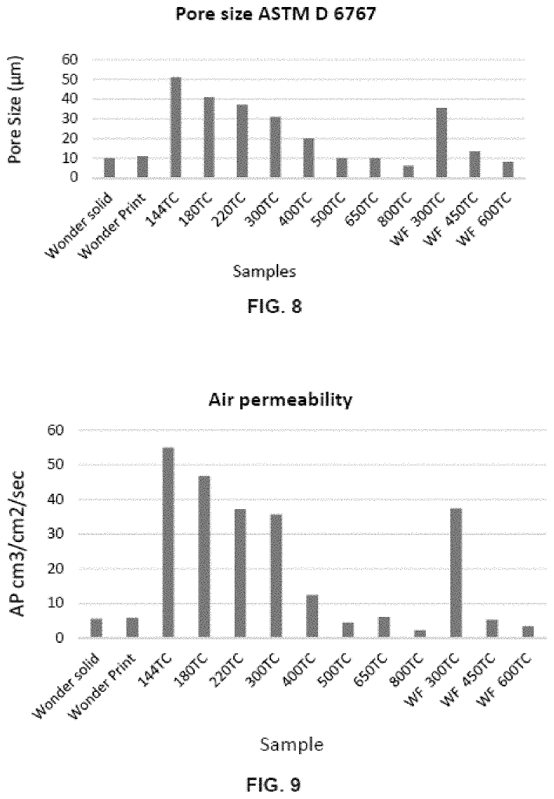

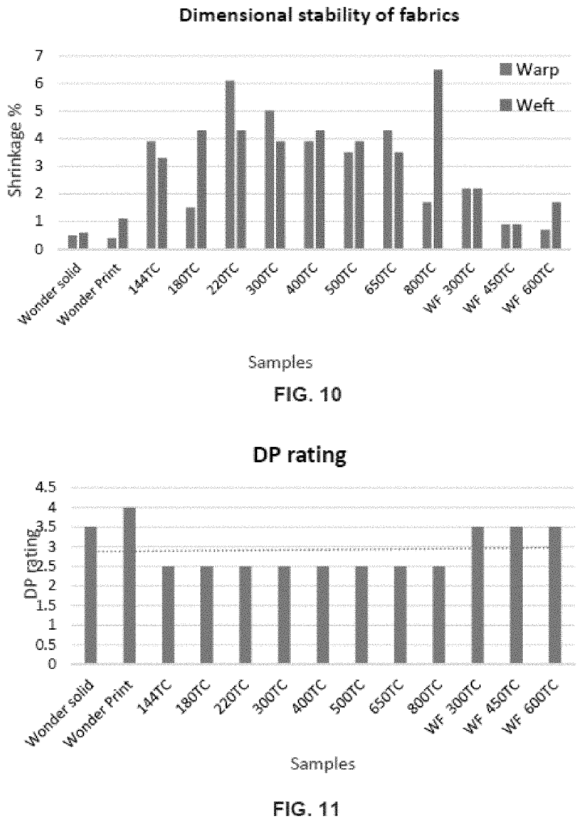

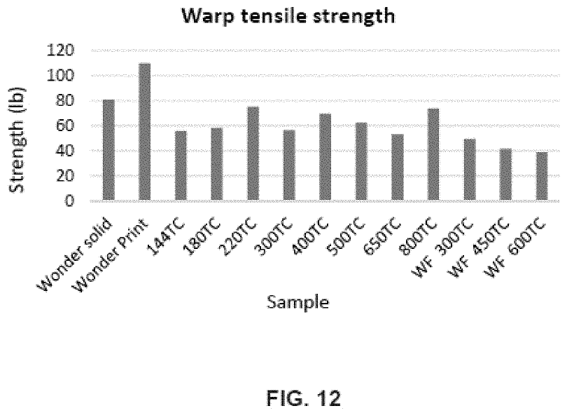

FIGS. 7 through 12 include data that is representative of an embodiment of the hydroentangled composite fabric described herein as compared to other fabrics used in the target applications. FIG. 8 shows an average pore diameter of 10 microns for an embodiment the hydroentangled composite fabric of the present disclosure. The pore size of samples S-1 and S-2 is indicative of an allergen barrier defined by the hydroentangled composite fabric 10 described in the present disclosure. Similarly, air permeability testing data shown in FIG. 9 illustrate low permeability values for samples S-1 and S-2 compared to all other fabrics. The air permeability testing may conducted according to ASTM D 737-96. In one embodiment of the hydroentangled composite fabric, air permeability using this method was shown to be less than six centimeters cubed/centimeters squared/second. FIG. 10 shows that a hydroentangled composite fabric 10 (see S-1 and S-2) of the present disclosure has better dimensional stability compared to other fabrics, exhibiting very low shrinkage when following AATCC 150 test method. FIG. 11 illustrates that the durable press rating of an embodiment of the hydroentangled composite fabric (see S-1 and S-2) to be at least 3.0 according to test method AATCC 143. Additional tests include testing for wicking distance in accordance with AATCC 197. The hydroentangled composite fabric 10 is shown to have a wicking distance of at least 13 centimeters according to this methodology as shown in FIG. 9. Tensile strength of warp is shown in FIG. 12. Tear strength of warp and weft are shown in FIG. 7, with each measurement showing results of no less than 2 pounds for one embodiment of the hydroentangled composite fabric according to test method ASTM D 1424-09. The hydroentangled composite fabric as described herein of one embodiment was shown to be free of formaldehyde according to BS EN ISO 14184 test methods (data not shown). Furthermore, the moisture wicking of the hydroentangled composite fabric is improved as compared to other fabrics tested. See FIG. 7. For instance, the tested embodiments were observed as having wicking distances of greater than 13 centimeters in length and width directions, higher than all other fabrics tested after 30 minutes according to AATCC 197. The improvement of moisture wicking may help absorb sweat quickly as well as to evaporate the absorbed sweat more quickly. This helps to enhance the comfort properties.

The inventive concepts disclosed herein result in a hydroentangled composite fabric with enhanced anti-allergen properties while retaining excellent strength, durability, colorfastness, moisture management and comfort properties suitable for bedding and other home textile applications.

An embodiment of the present disclosure further comprises a method for forming an anti-allergen hydroentangled composite fabric, comprising: weaving a plurality of warp yarns with a plurality of weft yarns to define a base woven fabric comprising pores with a diameter of at least about 40 microns; combining the base woven fabric with at least one web of nonwoven fibers; applying high pressure water jets to the base woven fabric and the at least one web of nonwoven fibers to generate a hydroentangled composite having pores with a diameter up to about 10 microns; and drying the hydroentangled composite fabric to substantially remove moisture from the hydroentangled composite fabric. An anti-allergen hydroentangled composite fabric produced by this method may include either or both of the warp yarns or the weft yarns comprising synthetic fibers, the method comprising heat setting the hydroentangled composite fabric. The method may further comprise pre-treating the base woven fabric with high pressure water jets before the step of applying high pressure water jets. The method may comprise applying high pressure water jets with an oscillating nozzle and may further comprise the high pressure water jets being applied at an angle. The high pressure range may be applied at a range of 50 bars to 400 bars.

It will be appreciated by those skilled in the art that various modifications and alterations of the present disclosure can be made without departing from the broad scope of the appended claims. Some of these have been discussed above and others will be apparent to those skilled in the art. The scope of the present disclosure is limited only by the claims.

1. A hydroentangled composite fabric, comprising:
a base woven fabric having a plurality of warp yarns, a plurality of weft yarns interwoven with the plurality of warp yarns, and interstitial spaces between the plurality of warp yarns and the plurality of weft yarns;
a web of nonwoven fibers hydroentangled a) within the interstitial spaces, and b) with the plurality of warp yarns and the plurality of weft yarns, such that, the nonwoven fibers are substantially entangled with each other and with fibers of the plurality of warp yarns and fibers of the plurality of weft yarns; and
a plurality of pores defined by the web of nonwoven fibers, the plurality of warp yarns, and the plurality of weft yarns, wherein the plurality of pores have a diameter up to about 10 microns.

2. The hydroentangled composite fabric of claim 1, having an air permeability of less than 6 centimeters cubed per centimeters squared per second according to test method ASTM D 737-96.

3. The hydroentangled composite fabric of claim 1, having a shrinkage is between +/−0.5 to +/−3.0 according to test method AATCC 150.

4. The hydroentangled composite fabric of claim 1, having a durable press rating of at least 3.0 according to test method AATCC 143 and no detectable formaldehyde content according to BS EN ISO 14184 test methods.

5. The hydroentangled composite fabric of claim 1, having a wicking distance of at least 10 but not more than 18 centimeters during a time period of thirty minutes according to test method AATCC 197.

6. The hydroentangled composite fabric of claim 1, having a tensile strength of at least 75 but not more than 110 pounds according to test method ASTM D 5034.

7. The hydroentangled composite fabric of claim 1, having a basis weight between 80 grams per square meter and 550 grams per square.

8. The hydroentangled composite fabric of claim 1, having a thread count between 100 and 1000.

9. The hydroentangled composite fabric of claim 1, wherein the base woven fabric has 1) a warp end density between about 50 warp ends per inch and about 350 warp ends per inch, and 2) a weft end density between about 50 weft yarns per inch and about 350 weft yarns per inch.

10. The hydroentangled composite fabric of claim 1, wherein either or both of the plurality of warp yarns and the plurality of weft yarns are selected from the group consisting of natural spun yarns, synthetic spun yarns, synthetic filament yarns, and blended yarns.

11. An anti-allergen hydroentangled composite fabric, comprising:
a base woven fabric having a plurality of warp yarns, a plurality of weft yarns interwoven with the plurality of warp yarns, and interstitial spaces between the plurality of warp yarns and the plurality of weft yarns;
a web of nonwoven fibers hydroentangled a) within the interstitial spaces, and b) with the plurality of warp yarns and the plurality of weft yarns, such that, the nonwoven fibers are substantially entangled with each other and with fibers of the plurality of warp yarns and fibers of the plurality of weft yarns; and
a plurality of pores defined by the web of nonwoven fibers, the plurality of warp yarns, and the plurality of weft yarns, wherein the plurality of pores have a diameter up to about 10 microns, thereby defining the anti-allergen hydroentangled composite fabric.

12. The anti-allergen hydroentangled composite fabric of claim 11, having an air permeability of less than 6 centimeters cubed per centimeters squared per second according to test method ASTM D 737-96.

13. The anti-allergen hydroentangled composite fabric of claim 11, having a shrinkage is between +/−0.5 to +/−3.0 according to test method AATCC 150.

14. The anti-allergen hydroentangled composite fabric of claim 11, having a durable press rating of at least 3.0 according to test method AATCC 143 and no detectable formaldehyde content according to BS EN ISO 14184 test methods.

15. The anti-allergen hydroentangled composite fabric of claim 11, having a wicking distance of at least 10 but not more than 18 centimeters during a time period of thirty minutes according to test method AATCC 197.

16. The anti-allergen hydroentangled composite fabric of claim 11, having a tensile strength of at least 75 but not more than 110 pounds according to test method ASTM D 5034.

17. The anti-allergen hydroentangled composite fabric of claim 11, having a basis weight between 80 grams per square meter and 550 grams per square meter.

18. The anti-allergen hydroentangled composite fabric of claim 11, having a thread count between 100 and 1000.
